(19) United States
(12) Patent Application Publication
(10) Pub. No.: US 2026/0106912 A1
(43) Pub. Date: Apr. 16, 2026

(54) METHOD FOR MANAGING A SMART METER

(71) Applicant: SAGEMCOM ENERGY & TELECOM SAS, Bois-Colombes (FR)

(72) Inventors: Jérémie SERGI, Bois-Colombes (FR); Antonio LOPES DA SILVA, Bois-Colombes (FR)

(73) Assignee: SAGEMCOM ENERGY & TELECOM SAS, Bois-Colombes (FR)

(21) Appl. No.: 19/354,575

(22) Filed: Oct. 9, 2025

(30) Foreign Application Priority Data
Oct. 10, 2024 (FR) 2410971

(51) Int. Cl. H04L 67/12; H04L 67/303

(52) U.S. Cl. CPC H04L 67/12; H04L 67/303

(57) ABSTRACT

A method for managing smart meters supplied by cell, for measuring consumption of a fluid, the smart meters being connected to a centralised platform for managing smart meters, the smart meter being in a given operating mode. The centralised platform: receives, from a smart meter, information representing the level of charge of the cell of the smart meter; obtains the age of the meter; determines, from the information representing the level of charge of the cell of the smart meter and from the age of the smart meter, whether the level of charge is below or above a nomogram representing a theoretical change in a level of charge of a battery over time; selects an operating profile of the smart meter according to the determination; and transfers the selected operating profile to the meter if the selected operating profile is different from the given operating profile of the meter.

### TECHNICAL FIELD

The invention relates to the field of smart meters supplied by cells and comprising a metering unit and relates more particularly to the field of managing smart meters supplied by cell for preserving the integrity of the measurements when the cell arrives at the end of its life.

### PRIOR ART

In a known manner, the Internet of Things (IoT) is rapidly growing. The Internet of Things represents the extension of the internet to things and places in the physical world. Whereas the internet is not normally extended beyond the electronic world, the Internet of Things represents exchanges of information and data coming from devices present in the real world to the internet, such as for example the collection of water-consumption readings or for remotely monitoring environmental conditions (temperature, pressure, etc.). The Internet of Things is considered to be the third evolution of the internet, named Web 3.0. The Internet of Things has a universal character for designating connected objects for varied uses, for example in the field of e-health or home automation.

A first approach adopted for interconnecting objects, referred to as communicating objects (“IoT devices”), in the context of the Internet of Things relies on a deployment, controlled by an operator, of collection gateways located on geographically high points. Apart from maintenance operations, these gateways are fixed and permanent. Mention can be made for example, with regard to this model, of the networks of the following types: NB-IoT (the acronym of the English term Narrowband Internet of things) or SigFox (registered trade mark) or ThingPark (registered trade mark).

NB-IoT uses the cellular network and has been developed by the 3GPP.

For example, in France, the SigFox network (registered trade mark) relies on the high points of the TDF (“Télédiffusion De France”) transmission sites.

These collection gateways communicate with the communicating objects by means of medium- or long-range communication systems (e.g. the LoRa system (registered trade mark) of the company Semtech). This approach relies on a limited number of collection gateways (difficulty in deploying new network infrastructures), as well as on a reliable and secure uplink access with one or more collection servers.

A second approach consists in connecting communicating objects through residential gateways. Mention can be made for example of the Energy Gateway technology. A system according to the Energy Gateway technology is composed of two distinct parts: firstly a residential gateway and peripheral sensors, which are hosted at the consumer and allow the collection of information, the transmission of this information to a collection server, and control of triggering of various actions (control of the triggering of the radiators or of the boiler for example); secondly the collection server, which makes available the information received and transmits commands for controlling triggering of various actions. This collection server is accessible via the internet. The radio technologies employed for communicating with the communicating objects according to the second approach are of relatively short range (for example of the following types: Zigbee (registered trade mark), Bluetooth (registered trademark) or Wi-Fi (registered trade mark), for serving a local collection restricted to the objects in the dwelling.

Such communicating objects typically include one or more sensors, and are typically supplied by cells (or batteries). One difficulty lies in preserving the service life of the cells, and more particularly in guaranteeing the operation of the essential functionalities of such communicating objects throughout the service life of the cells.

It is desirable to overcome these drawbacks of the prior art. It is in particular desirable to provide a solution that makes it possible to ensure the integrity of the data stored and/or supplied by these communicating objects when their cells arrive at the end of their life, and this while minimising any additional hardware cost that such a solution would entail. It should be noted that additional hardware cost generally entails a larger space requirement (for example capacitive elements are more expensive and more bulky than transistors or resistors).

Thus it is desirable to provide a method for managing a communicating object making it possible to guarantee the supply of electrical energy to the communicating object for a predefined period.

The communicating objects are for example smart meters and the invention makes it possible to extend the capacities of the cells for supplying electrical energy to the smart meter for a predetermined period while guaranteeing optimum measurements of fluid consumption (gas, water, etc.).

### DISCLOSURE OF THE INVENTION

For this purpose, according to a first aspect, a method is proposed for managing smart meters supplied by cells, for measuring consumption of a fluid, the smart meters being connected to a centralised platform for managing smart meters, the smart meter being in a given operating mode, characterised in that the method comprises the steps, performed by the centralised smart-meter management platform of:
receiving, from a smart meter, information representing a level of charge of the cell of the smart meter,
obtaining the age of the smart meter,
determining, from the information representing the level of charge of the cell of the smart meter and from the age of the smart meter, whether the level of charge is below or above a nomogram representing a theoretical change in a level of charge of a battery over time,
selecting an operating profile of the smart meter according to the determination,
transferring the selected operating profile to the smart meter if the selected operating profile is different from the given operating level of the smart meter.

The invention also relates to a device for managing smart meters supplied by cells, for measuring consumption of a fluid, the smart meters being connected to a centralised smart-meter management platform, the smart meter being in a given operating mode, characterised in that the management device is included in the centralised smart-meter management platform and comprises:
means for receiving, from a smart meter, information representing the level of charge of the cell of the smart meter,
means for obtaining the age of the smart meter,
means for determining, from the information representing the level of charge of the cell of the smart meter and from the age of the smart meter, whether the level of charge is below or above a nomogram representing a theoretical change in a level of charge of a battery over time,
means for selecting an operating profile of the smart meter according to the determination,
means for transferring the selected profile to the smart meter if the selected level is different from the given operating level of the smart meter.

Thus the present invention makes it possible to adapt the operating profile of smart meters according to the level of charge of the cells of the smart meters and makes it possible to increase the service life of the smart meters. The invention being implemented by a centralised smart-meter management platform, the service life of the cells of the smart meters is increased.

According to a particular embodiment, the method is iterative and, when a selected operating profile is different from the given operating profile of the smart meter, the method furthermore comprises a step of waiting for a predetermined time before implementing a new iteration of the method.

According to a particular embodiment, the determination, selection and transfer steps are dependent on a dynamic profile of the smart meter.

According to a particular embodiment, at least three different profiles can be selected:
a first profile in which the smart meter is in a nominal operating mode,
a second profile in which the smart meter is in a degraded operating mode,
a third profile in which the smart meter is in a minimum operating mode,

According to a particular embodiment, if the given operating profile is the first profile, the selected profile is the first or second profile, if the given operating profile is the second profile, the selected profile is the first or second or third profile and, if the given operating profile is the third profile, the selected profile is the second or third profile.

According to a particular embodiment, the given operating profile is the second profile, the method prior to the selection of the first profile checks whether the level of charge is higher than the nomogram representing a theoretical change in a level of charge on a battery over time by a predetermined percentage number.

According to a particular embodiment, if the level of charge is lower than the nomogram representing a theoretical change in a level of charge of a battery over time, the method furthermore comprises the steps of linear extrapolation of the electrical-energy consumption of the smart meter until the end of life of the cell predicted by the manufacturer of the smart meter from the electrical-energy consumption of the smart meter over a period of time, and of checking whether the extrapolated consumption is below or equal to the information representing the charge level of the cell of the smart meter, and in that an operating profile different from the given operating profile is selected if the extrapolated consumption is lower than or equal to the information representing the charge level of the cell of the smart meter.

According to another aspect, a non-transient storage medium is proposed, on which a computer program is stored comprising program code instructions for executing the management method, when said instructions are read from said non-transient storage medium and executed by a processor.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an example of architecture of a system for collecting data from smart meters supplied by a cell;

FIG. 2 illustrates schematically an example of hardware architecture of a centralised platform for managing smart meters supplied by cells;

FIG. 3 is a flow diagram of a method for monitoring the service life of smart meters supplied by cells;

FIG. 4 is a flow diagram of a method for adapting the operation of smart meters supplied by cells;

FIG. 5 is an example of change in the electrical consumption of a smart meter supplied by cells and of a nomogram used by the present invention.

### DETAILED DISCLOSURE OF EMBODIMENTS

FIG. 1 illustrates schematically an example of architecture of a system for collecting data from smart meters supplied by a battery.

The collection system comprises a centralised platform HES for managing smart meters supplied by cell connected by a secure private network SPN to smart meters supplied by cells CPT1 to CPTN.

The term “cell” must be understood as being a single cell, or set of cells conjointly providing an autonomous electrical energy source.

The present invention is described in a particular embodiment where the communicating object is a fluid meter, i.e. one adapted and configured to measure consumption of a fluid (water, gas, etc.). The present invention is also applicable to communicating objects such as energy (electricity) measurement systems or sensors for temperature, pressure, humidity, etc.

Each smart meter CPT1 to CPTN comprises in particular a measuring unit for acquiring measurements, a communication unit, a signalling unit for sending alarm signals, and a control unit, none shown in FIG. 1.

Typically, the measuring unit can be adapted and configured to measure consumption of water, or consumption of another fluid such as gas.

The communication unit comprises a set of communication members for transmitting measurements acquired by the measuring unit, for example to a collection gateway or to a residential gateway.

Typically, the communication unit comprises members for communication via a telephone network, via internet (communication-on-IP protocols, via a LoRa (registered trade mark) system of the company Semtech, via a Wi-Fi (registered trade mark) system, via a system of the Zigbee (registered trade mark) type, via a system of the Bluetooth (registered trade mark) type, via a low-power wide area network (LPWAN), or via a cellular network dedicated to the Internet of Things of the NB-IOT (“Narrowband Internet Of Things”) type or of the LTE Cat-M (“Long Term Evolution—Category Machine”) type.

The service life of a smart meter CPT1 to CPTN is generally a multiple of ten years. It is difficult to size the cell to absorb all contingencies and changes in use of a smart meter for such a long period.

The energy consumption of a smart meter can be broken down into two categories. A first category contains the consumptions related to the electronics and to the software operation. The elements of the first category are by nature deterministic and can be determined at the time of design and qualification of the smart meter. The ageing models of the electronic components are also well known and mastered.

A second category relates to the consumption relating to the exchange of data by a secure private network SPN. The elements of the second category are by nature non-deterministic since they are dependent on several factors that may greatly change during the years of the service life of the cell and of the smart meter. These factors are for example the coverage of the cellular network, the load on the cell of the cellular network and the usage of the smart meter such as updating, reading data on demand, etc..

The non-deterministic energy consumption may be preponderant, which poses a problem for guaranteeing the service life of the smart meter.

The present invention makes it possible to ensure, automatically and by time projection, a minimum service life of a smart meter supplied by cell, and this over several years, whereas the conditions of radio environment and usage may greatly vary over such a long period. It is in fact practically impossible to predict the change in the radio conditions and the change in business usage (in addition to periodic sendings) triggered by the operator of the smart meters, software updates, readings and actions on demand.

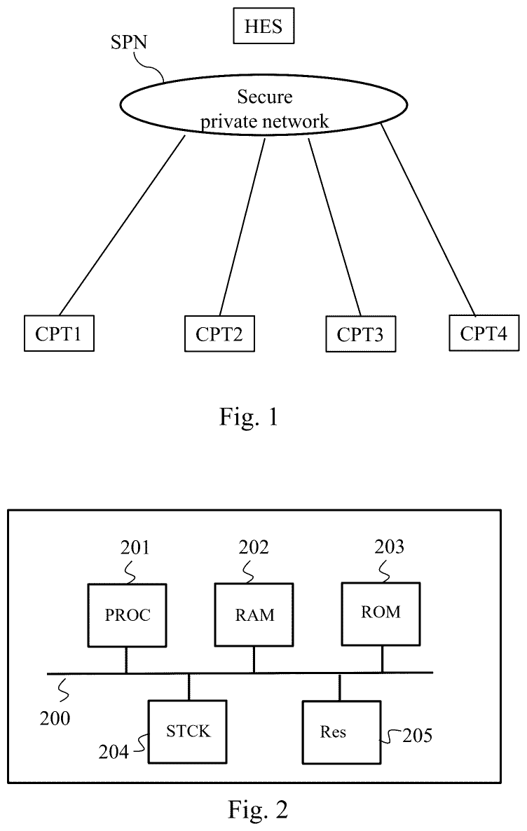

FIG. 2 illustrates schematically an example of hardware architecture of a centralised platform for managing smart meters supplied by cells;

According to this example, the centralised smart-meter management platform HES comprises, connected by a communication bus 200: a processor PROC or CPU (“Central Processing Unit”) 201; a random access memory RAM 202; a read-only memory ROM 203, a storage unit or a storage medium reader, such as an SD (“Secure Digital”) card reader 204; a radio interface Res 205 enabling the centralised smart-meter management platform HES to communicate with the smart meters CPT1 to CPTN.

The processor 201 is capable of executing instructions loaded in the RAM 202 from the ROM 203, from an external memory, from a storage medium, or optionally from a communication network. When the centralised smart-meter management platform HES is powered up, the processor 201 is capable of reading instructions from the RAM 202 and executing them. These instructions for my computer program causing the implementation, by the processor 201, of all or part of the management method described below.

All or part of the management method described below can thus be implemented in software form by executing a set of instructions by a programmable machine, such as a DSP (“digital signal processor”) or a microcontroller. All or some of the algorithms and steps described here can also be implemented in hardware form by a machine or a dedicated component such as an FPGA (“field-programmable gate array”) or an ASIC (“application-specific integrated circuit”).

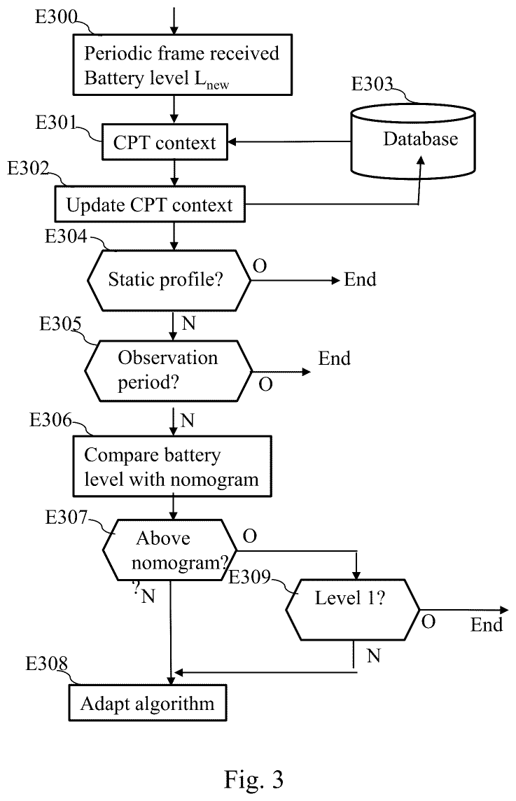

FIG. 3 is a flow diagram of a method for monitoring the service life of smart meters supplied by cells.

The present algorithm is executed by the centralised smart-meter management platform HES for each smart meter CPT1 to CPTN.

Centralising the management method allows unified processing of the data coming from all the smart meters. This approach offers a global view of the network, which facilitates rapid detection of abnormalities, energy drifts and unusual behaviours.

By grouping together the management functions in a single platform, the operational costs are reduced, in particular by limiting local interventions and simplifying the updating of the software. Security is also reinforced by virtue of centralised control of accesses and homogeneous application of cybersecurity measures.

Maintenance is more effective, with more precise diagnosis and better planning of interventions. Centralisation also allows optimised management of resources, based on a consolidated vision of the system. Finally, centralised analysis of performances, in comparison with reference models, improves the detection of divergences and optimisation of the operation of the equipment.

This algorithm makes it possible to monitor the state of the cell of each smart meter.

At the step E300, the centralised smart-meter management platform HES detects the reception of a frame sent by a smart meter. The frame sent by the smart meter comprises at least one unique identifier of the smart meter and information representing the cell level L_{new} of the smart meter.

The information representing the cell level is for example expressed as a percentage with respect to the maximum charge capacity of the cell. The information representing the cell level can example be expressed in volts.

At the following step E301, the centralised smart-meter management platform HES obtains, from a database denoted E303, information associated with the smart meter that sent the data frame.

The information associated with the smart meter comprises, by means of information representing the age of the smart meter, the previously defined profile of the smart meter and the previously received cell level of the smart meter. The information associated with the smart meter may also comprise other information such as the number of frames sent and received by the smart meter, information indicating whether the profile of the smart meter can be modified or not (in other words whether the profile is static or dynamic), and information indicating whether the smart meter is in a so-called observation period.

The information indicating whether the profile of the smart meter can or must not be modified is for example defined by the operator of the service platform. This information can be modified by the fluid-supply operator at any time. When the profile of the smart meter can be modified, this is called dynamic profile. When the profile of the smart meter must not be modified, this is called static profile.

The observation period is for example a period during which, when a change in profile of the smart meter is made, the profile of the smart meter is no longer modified in order to avoid excessively quick changes between two profiles that are detrimental to the electrical energy consumption of the smart meter.

For example, the duration of the observation period is for example at a minimum one month. The observation period is for example initialised to the value zero representing non-activation thereof. When it is activated, a countdown equal to 1 month is triggered which, at the end of the observation period, arrives at the zero value.

At the following step E303, the centralised smart-meter management platform HES updates the profile of the smart meter with the frame received and the information that it comprises and demands storage of the updated profile in the database.

At the following step E304, the centralised smart-meter management platform HES checks whether the profile of the smart meter is static.

If so, the centralised smart-meter management platform HES interrupts the present algorithm.

If not, the centralised smart-meter management platform HES passes to the step E305.

At the step E305, the centralised smart-meter management platform HES checks whether an observation period is associated with the smart meter.

If so, the centralised smart-meter management platform HES interrupts the present algorithm.

If not, the centralised smart-meter management platform HES passes to the step E306.

At the step E306, the centralised smart-meter management platform HES compares the information representing the cell level L_{new} of the smart meter with a predefined nomogram representing a change in the cell level as a function of the age of the meter.

Such a predefined nomogram is an advance theoretical representation of the change in the charge level over time. It is thus possible not only to follow an expected energy trajectory, but also to detect any abnormal drifts, revealing premature malfunctioning or accelerated wear.

At the following step E307, the centralised smart-meter management platform HES checks, from the age of the smart meter, whether the information representing the cell level L_{new} of the smart meter is higher than the cell level for the age of the meter of the nomogram.

If so, the centralised smart-meter management platform HES passes to the step E309. If not, the centralised smart-meter management platform HES passes to the step E308.

At the step E308, the centralised smart-meter management platform HES checks whether the previously defined profile of the smart meter is equal to 1. If so, the centralised smart-meter management platform HES interrupts the present algorithm.

If not, the centralised smart-meter management platform HES passes to the step E308.

The step E308 consists in launching the algorithm for adapting the operation of smart meters supplied by cells;

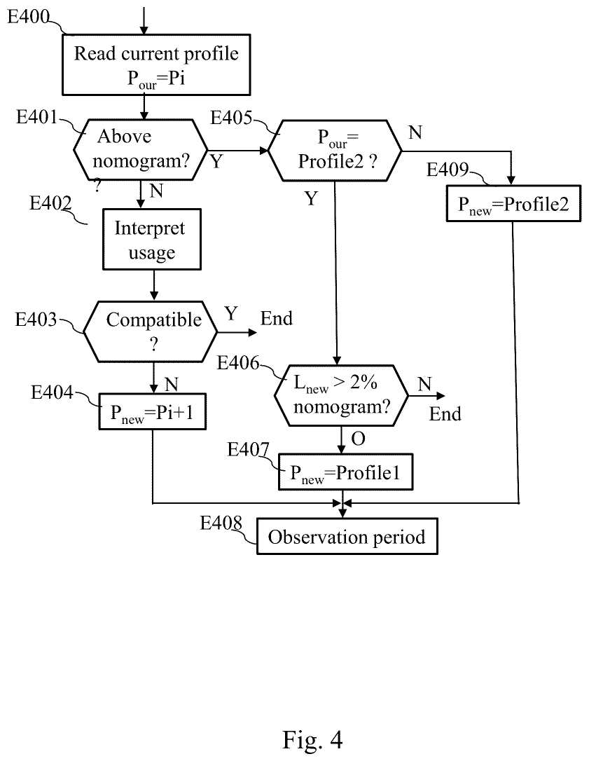

The step E308 is described in more detail with reference to FIG. 4.

FIG. 4 is a flow diagram of a method for adapting the operation of smart meters supplied by cells.

This algorithm consists in adapting the profile of the smart meter.

Each profile denoted P contains technical parameters to be applied to the smart meter. The list of parameters and the values thereof will be determined in advance and selected in order to establish a balance between energy consumption and accuracy of the information.

The profile 1 is a normal profile offering optimum balance provided when the smart meter was designed. The profile 1 is applied by default when a smart meter is commissioned. The higher the profile number, the lower the accuracy of the information, to the benefit of an increase in the service life of the cell. The number of profiles is therefore not limited but, in the example as described, three profiles are defined. The profile 1 corresponds to normal operation, the profile 2 corresponds to degraded operation and the profile 3 corresponds to extreme operation.

Each profile contains a set of technical parameters that are configured in the smart meter when the latter is installed. The list of technical parameters depends on the capacities offered by the data model of the smart meter and its capacities. For example, the period in which useful metering data are sent, and the depth of the data buffer sent at each period. This is because it is common to implement, at the smart meter, an error recovery functionality, so that, if the smart meter has not succeeded in communicating data during a period, it will resend the data during the following period in combination with the sent data that are normally to be sent at the following period and so on. Limiting this depth therefore limits the duration of communication for smart meters suffering from poor radio coverage.

The algorithm proposed complies with the following rules:

The change to a profile takes place only to the adjacent profile, both upwards and downwards.

At the step E400, the centralised smart-meter management platform HES obtains the profile of the smart meter from the database E303.

At the step E401, the centralised smart-meter management platform HES checks, from the age of the smart meter, whether the information representing the cell level L_{new} of the smart meter is higher than the cell level for the age of the meter of the nomogram.

If not, the centralised smart-meter management platform HES passes to the step E402.

If so, the centralised smart-meter management platform HES passes to the step E405.

At the step E402, the centralised smart-meter management platform HES makes an interpretation of the electrical-energy use of the smart meter. The centralised smart-meter management platform HES makes, from the electrical-energy consumption of the smart meter HES over a period of time, a linear extrapolation of the electrical-energy consumption of the smart meter HES until the end of life of the cell predicted by the manufacturer of the smart meter. The period of time is for example equal to the observation period, typically 1 month.

At the step E403, the centralised smart-meter management platform HES checks whether the extrapolated consumption is less than or equal to the information representing the cell level L_{new} of the smart meter. If not, the centralised smart-meter management platform HES passes to the step E404. If so, the centralised smart-meter management platform HES interrupts the present algorithm.

At the step E404, the centralised smart-meter management platform HES increments the profile of the meter by one unit, i.e., if the current profile Pₒᵤᵣ of the smart meter is profile 1, the new profile P_{new} is profile 2 and, if the current profile Pₒᵤᵣ of the smart meter is profile 2, the new profile P_{new} is profile 3.

As the present invention is described in an example with three profiles, if the profile of the smart meter were profile 3, the new profile remains profile 3.

Once this operation has been performed, the centralised smart-meter management platform HES passes to the step E408.

At the step E405, the centralised smart-meter management platform HES checks whether the current profile Pₒᵤᵣ of the smart meter is profile 2.

If so, the centralised smart-meter management platform HES passes to the step E406.

If not, the centralised smart-meter management platform HES passes to the step E409.

At the step E409, the centralised smart-meter management platform HES sets the new profile P_{new} to profile 2 and then passes to the step E408.

At the step E406, the centralised smart-meter management platform HES checks whether the information representing the cell level L_{new} of the smart meter is higher than a predetermined percentage, for example 2% at the cell for the age of the corresponding smart meter in the nomogram.

If so, the centralised smart-meter management platform HES passes to the step E407.

If not, the centralised smart-meter management platform HES interrupts the present algorithm.

At the step E407, the centralised smart-meter management platform HES sets the new profile P_{new} to profile 1 and then passes to the step E408.

At the step E408, the centralised smart-meter management platform HES triggers an observation period P_{obs} and, if the profile selected is different from the given operating profile of the smart meter, demands transfer of a message to the smart meter indicating to it the new profile P_{new} to be applied.

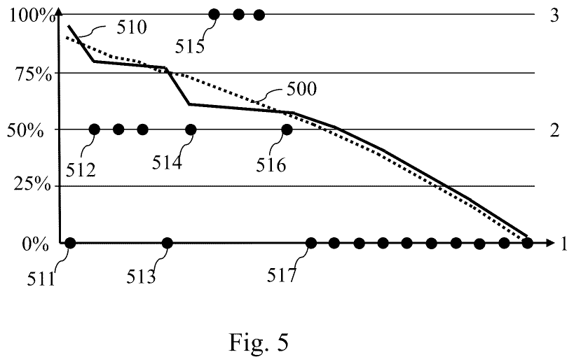

FIG. 5 is an example of change in the electrical consumption of a smart meter supplied by cells and of a nomogram used by the present invention.

The X-axis shows the time and the Y-axis shows on the left the charge level of the cell or the charge level of the nomogram and on the right the level of the profile: 1 for profile 1, 2 for profile 2 and 3 for profile 3.

The nomogram is for example determined following endurance and accelerated-ageing tests in the laboratory.

The curve denoted 500 represents the values of the nomogram and the curve 510 represents the change in the actual charge level of the cell.

For example, during the first year 511, the consumption of the meter is less than the model. The profile 1 therefore remains applied.

In the second year 512, following frequent software updates, the voluminous exchanges of data have significantly reduced the level of the cell, passing below the nomogram, and the profile 2 is then applied. The profile 2 is then applied for 3 years as long as the level of the cell remains below the nomogram.

In the fifth year 513, the charge level of the battery goes above the nomogram and the profile 1 is then applied.

In the sixth year 514, changing radio conditions (modification of the cell plan of the operator) exhaust the battery. The profile 2 is applied, insufficient, which then triggers in the seventh year 515 an application of the profile 3, and this for a period of 3 years. In the tenth year 516, the charge level of the cell goes above the nomogram and the profile 2 is then applied.

In the eleventh year 517, the charge level of the cell is above the nomogram and the profile 1 is then applied.

The present disclosure makes it possible to detect in advance a drift towards an overconsumption situation, even before a critical threshold is reached. This early detection makes it possible to anticipate risks, to dynamically adapt the consumption profile, and to automatically establish nominal functioning as soon as the cause of the overconsumption is solved.

Moreover, centralised management of the consumption profiles allows rapid adjustments, of the order of a few minutes to a few hours, without requiring modifying the firmware loaded in the individual meters. This centralised approach offers great operational flexibility and allows real-time updating of the operating parameters over the whole of the network, ensuring optimised continuity of service and better adaptability to real conditions of use.

1. A method for managing smart meters supplied by cell, for measuring consumption of a fluid, the smart meters being connected to a centralised platform for managing smart meters, the smart meter being in a given operating mode, wherein the method comprises the steps, performed by the centralised smart-meter management platform of:
receiving, from a smart meter, information representing a level of charge of the cell of the smart meter,
obtaining the age of the smart meter,
determining, from the information representing the level of charge of the cell of the smart meter and from the age of the smart meter, whether said level of charge is below or above a nomogram representing a theoretical change in a level of charge of a battery over time,
selecting an operating profile of the smart meter according to the determination,
transferring said selected operating profile to the smart meter if said selected operating profile is different from the given operating profile of the smart meter.

2. The method according to claim 1, wherein the method is iterative and, when a selected operating profile is different from the given operating profile of the smart meter, the method furthermore comprises a step of waiting for a predetermined time before implementing a new iteration of the method.

3. The method according to claim 1, wherein the determination, selection and transfer steps are dependent on a dynamic profile of the smart meter.

4. The method according to claims 1, claim 1, wherein at least three different profiles can be selected:
a first profile in which the smart meter is in a nominal operating mode,
a second profile in which the smart meter is in a degraded operating mode,
a third profile in which the smart meter is in a minimum operating mode.

5. The method according to claim 4, characterised in that, wherein, if the given operating profile is the first profile, the selected profile is the first or second profile, if the given operating profile is the second profile, the selected profile is the first or second or third profile and, if the given operating profile is the third profile, the selected profile is the second or third second profile.

6. The method according to claim 5, wherein, if the given operating profile is the second profile, the method prior to the selection of the first profile checks whether the level of charge is higher than the nomogram representing a theoretical change in a level of charge on the battery over time by a predetermined percentage number.

7. The method according to claim 5, wherein, if the level of charge is lower than the nomogram representing a theoretical change in a level of charge of a battery over time, the method furthermore comprises the steps of linear extrapolation of the electrical-energy consumption of the smart meter until the end of life of the cell predicted by the manufacturer of the smart meter from the electrical-energy consumption of the smart meter over a period of time, and of checking whether the extrapolated consumption is below or equal to the information representing the charge level of the cell of the smart meter, and in that an operating profile different from the given operating profile is selected if the extrapolated consumption is lower than or equal to the information representing the charge level of the cell of the smart meter.

8. A device for managing smart meters supplied by cells, for measuring consumption of a fluid, the smart meters being connected to a centralised smart-meter management platform, the smart meter being in a given operating mode, characterised in that wherein the management device is included in the centralised smart-meter management platform and comprises electronic circuitry configured for:
means cell of the for smart receiving, meter, from a smart meter, information representing a level of charge of the cell of the small meter,
obtaining the age of the smart meter,
determining, from the information representing the level of charge of the cell of the smart meter and from the age of the smart meter, whether said level of charge is below or above a nomogram representing a theoretical change in a level of charge of a battery over time,
selecting an operating profile of the smart meter according to the determination,
transferring the selected operating profile to the smart meter if said selected operating profile is different from the given operating profile of the smart meter.

9. (canceled)

10. A non-transient transitory storage medium on which a computer program is stored comprising program code instructions for executing the management method according to claim 1, when said instructions are read from said non-transient storage medium and executed by a processor.
